(19) United States
(12) Patent Application Publication
(10) Pub. No.: US 2026/0019851 A1
(43) Pub. Date: Jan. 15, 2026

(54) EVENT-TRIGGERED BEAM AVOIDANCE PREDICTION REPORT

(71) Applicant: QUALCOMM Incorporated, San Diego, CA (US)

(72) Inventors: Qiaoyu LI, Beijing (CN); Tao LUO, San Diego, CA (US); Hamed PEZESHKI, San Diego, CA (US); Mahmoud TAHERZADEH BOROUJENI, San Diego, CA (US)

(21) Appl. No.: 18/992,086

(22) PCT Filed: Sep. 5, 2022
(86) PCT No.: PCT/CN2022/116955

§ 371 Date: Jan. 7, 2025

(51) Int. Cl. H04W 24/10; H04B 7/06; H04L 41/16; H04W 72/0446; H04W 72/1263

(52) U.S. Cl. CPC H04W 24/10; H04B 7/0626; H04L 41/16; H04W 72/0446; H04W 72/1263

(57) ABSTRACT

Methods, systems, and devices for wireless communication are described. A user equipment (UE) may detect an event based on a first quantity of reference signal resources, where the event may be based on some predicted, future beam blockage. The event may trigger the UE to generate a report that indicates a second quantity of reference signal resources to be avoided by a network entity within a first set of time domain windows, where the second quantity of reference signal resources is a subset of the first quantity of reference signal resources. Alternatively, the report may indicate just the first set of time domain windows. In some examples, the report may include confidence level corresponding to a reference signal resource, a time domain window, or both, where a confidence level indicates a predicted level of severity of a beam blockage. The UE may transmit the report to the network entity.

### CROSS REFERENCE

The present Application is a 371 national stage filing of International PCT Application No. PCT/CN2022/116955 by LI et al. entitled “EVENT-TRIGGERED BEAM AVOIDANCE PREDICTION REPORT,” filed Sep. 5, 2022, which is assigned to the assignee hereof, and which is expressly incorporated by reference in its entirety herein.

### FIELD OF TECHNOLOGY

The following relates to wireless communication, including event-triggered beam avoidance prediction reports.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

In some wireless communications systems, a UE may perform some beam failure detection (BFD) procedure to predict whether a given beam is blocked. In some cases, however, techniques for reporting blocked beam predictions may be improved.

### SUMMARY

The described techniques relate to improved methods, systems, devices, and apparatuses that support event-triggered beam avoidance prediction reports. For example, the described techniques provide for an event-triggered user equipment (UE) beam avoidance prediction report, which may enable a UE to predict and report blocked reference signal resources during future time domain windows such that a network entity may proactively avoid using those resources during the indicated time domain windows. In some examples, a UE may detect an event based on a first quantity of reference signal resources, where the event may be based on some indication of a predicted beam blockage. The event may trigger the UE to generate a report that indicates a second quantity of reference signal resources to be avoided by a network entity within a set of time domain windows, the second quantity of reference signal resources a subset of the first quantity of reference signal resources. Additionally, or alternatively, the report may indicate the set of time domain windows. In some examples, the report may include confidence levels which may indicate predicted levels of beam blockage severities for the second set of reference signal resources during the set of time domain windows. In some cases, the UE may include the second set of reference signals in the report based on corresponding transmission configuration indicator (TCI) states. The UE may transmit the report to the network entity, which may avoid using the second set of reference signal resources during the set of time domain windows accordingly.

### BRIEF DESCRIPTION OF THE DRAWINGS

FIGS. 1 through 3 illustrates examples of a wireless communications systems that support event-triggered beam avoidance prediction reports in accordance with one or more aspects of the present disclosure.

FIG. 4 illustrates an example of a process flow that supports event-triggered beam avoidance prediction reports in accordance with one or more aspects of the present disclosure.

FIGS. 5 and 6 show block diagrams of devices that support event-triggered beam avoidance prediction reports in accordance with one or more aspects of the present disclosure.

FIG. 7 shows a block diagram of a communications manager that supports event-triggered beam avoidance prediction reports in accordance with one or more aspects of the present disclosure.

FIG. 8 shows a diagram of a system including a device that supports event-triggered beam avoidance prediction reports in accordance with one or more aspects of the present disclosure.

FIGS. 9 through 12 show flowcharts illustrating methods that support event-triggered beam avoidance prediction reports in accordance with one or more aspects of the present disclosure.

### DETAILED DESCRIPTION

In some wireless communications systems, a user equipment (UE) may use artificial intelligence (AI) or machine learning model-based techniques to predict a beam blockage. For example, a moving object (e.g., a pedestrian, a vehicle) may block transmissions from a network entity, and the UE may use a machine learning model to predict the object's movement such that the network entity and the UE avoid using blocked beams. However, explicitly predicting the object's moving direction, pattern, and speed may rely on a highly sophisticated machine learning model (e.g., using inputs from cameras and sensors on the moving object), which may be too complex and impractical for some scenarios. Moreover, predicting and reporting the object's moving direction may be associated with a high overhead consumption in three dimensional (3D) environments. In some examples, UEs may use beam failure detection (BFD) procedures to monitor beam performance regarding current operations, however, the UEs may fail to predict future beam blockages, which may be useful for low-latency communications. Additionally, or alternatively, UEs may predict the changes of beams being blocked instead of directly reporting blocked beams, which may reduce accuracy of beam blockage predictions and may result in future dropped transmissions.

Techniques described herein support an event-triggered UE beam avoidance prediction report, which may enable a UE to predict and report blocked reference signal resources during future time domain windows such that a network entity may proactively avoid using those resources during the indicated time domain windows. In some examples, a UE may detect an event based on a first quantity of reference signal resources, where the event may be based on some indication of a predicted beam blockage. The event may trigger the UE to generate a report that indicates a second quantity of reference signal resources to be avoided by a network entity within a set of time domain windows, the second quantity of reference signal resources a subset of the first quantity of reference signal resources. Additionally, or alternatively, the report may indicate the set of time domain windows. In some examples, the report may include confidence levels which may indicate predicted levels of beam blockage severities for the second set of reference signal resources during the set of time domain windows. In some cases, the UE may include the second set of reference signals in the report based on corresponding transmission configuration indicator (TCI) states. The UE may transmit the report to the network entity, which may avoid using the second set of reference signal resources during the set of time domain windows accordingly.

In this way, the described techniques may support higher data dates, increased signaling capacity, and increased spectral efficiency as the UE and the network entity may avoid using blocked beams and thus, avoid dropped transmissions. Additionally, reporting reference signal resources in future time domain windows for the network entity to avoid may reduce overhead consumption at the UE by reducing prediction complexity, and improve overall communications between the UE and the network entity by ensuring transmissions are scheduled using unblocked beams in the future.

Aspects of the disclosure are initially described in the context of wireless communications systems. Aspects of the disclosure are then described in the context of process flows. Aspects of the disclosure are further illustrated by and described with reference to apparatus diagrams, system diagrams, and flowcharts that relate to event-triggered beam avoidance prediction reports.

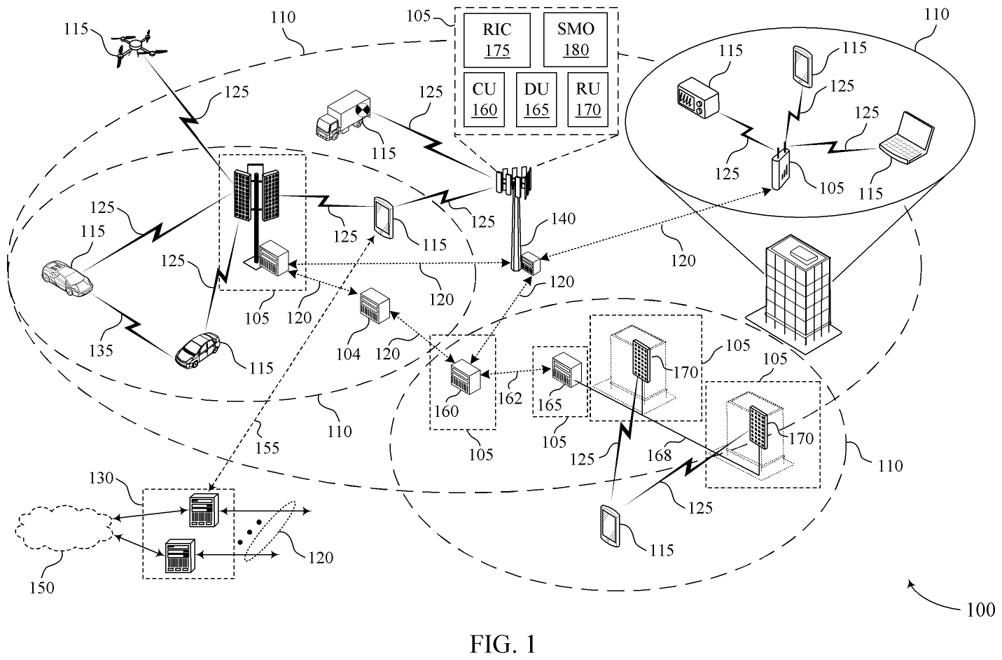

FIG. 1 illustrates an example of a wireless communications system 100 that supports event-triggered beam avoidance prediction reports in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support event-triggered beam avoidance prediction reports as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IOT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier (ID) for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

Using some beam management procedures, a UE 115 may identify beam qualities and failures using measurements (e.g., reference signal received power (RSRP) measurements). These measurements may increase power and overhead consumption at the UE 115 if the UE 115 is to achieve improved signaling performance. In addition, restrictions to power and overhead consumption may limit beam accuracy, and beam resuming efforts may increase latency and decrease signaling throughput. To reduce such power and overhead consumption, and to improve beam accuracy, latency, and throughput, a UE 115 may use predictive beam management (in the time domain, frequency domain, and spatial domain). Using predictive beam management techniques, the UE 115 may predict non-measured beam qualities, which may result in lower power and overhead or improved beam accuracy, and the UE 115 may predict future beam blockages or failures, which may improve latency and signaling throughput.

In some examples, UEs 115 may use AI or machine learning model-based predictive beam management procedures because beam prediction is highly non-linear. For example, predicting qualities of future transmit beams may depend on a moving speed or trajectory of the UE 115, which receive beams the UE 115 may use, interference, and other factors that may be difficult to model via statistical signaling processing methods. In some examples, a wireless device (e.g., a UE 115 or a network entity 105) may use a machine learning model for beam prediction in the time domain, the spatial domain, or both for overhead and latency reduction and improvements in beam selection accuracy.

Whether a UE 115 or a network entity 105 performs the machine learning model-based beam management may be based on performance and power of the UE 115. For example, to predict future downlink transmit beam qualities, a UE 115 may make more observations (e.g., via measurements) than a network entity 105 (e.g., via UE feedback), thus predictions made by the UE 115 may outperform those made by the network entity 105 as the UE 115 may consume less power for interference efforts. Moreover, training the machine learning model at the UE 115 or the network entity 105 may be based on data collection efforts and UE computation. For example, training the machine learning model at the network entity 105 may include collecting data via an air interface (e.g., an enhanced air interface) or via an Application (APP) layer approach. Alternatively, training the machine learning model at the UE 115 may include additional computation or buffering efforts at the UE 115 to perform accurate model training and adequate data storage.

In some examples of AI or machine learning model-based beam management, wireless devices may support two cases of beam management for characterization and baseline performance evaluations. In a first case (e.g., BM-Case 1), a UE 115 may perform spatial-domain downlink beam predictions for a first set of beams (e.g., Set A) based on measurement results of a second set of beams (e.g., Set B). In some cases, the second set of beams may be a subset of the first set of beams, where the first and second sets of beams may be different (e.g., the first set of beams may include narrow beams, and the second set of beams may include wide beams). Additionally, or alternatively, the UE 115 may use the first set of beams for downlink beam prediction and the second set of beams for downlink beam measurement. In a second case (e.g., BM-Case2), the UE 115 may perform temporal downlink beam prediction for the first set of beams based on historic (e.g., previous, past) measurement results of the second set of beams. For both cases, beams in the first and second set of beams may be in a same frequency range.

A wireless device may use different beam blockage prediction metrics in machine learning model-based beam management. For example, a wireless device may use an RSRP signature as an input to an AI or machine learning model, where the RSRP signature may include a set of RSRP measurements of a single beam or a pre-blockage RSRP signature. In some cases of network entity-based beam prediction, a network entity 105 may use an RSRP signature report and BFD suspension in beam management. The network entity 105 may use RSRP signature feedback, where RSRPs are efficiently reported across various spatial directions (e.g., transmit beam-based via a CSI-RS with repetition-off, or receive beam-based via CSI-RS with repetition-on). Additionally, or alternatively, the network entity 105 may use ordered BFD suspension based on a predicted future beam blockage, where a UE 115 may suspend BFD for a BFD reference signal predicted to be blocked to avoid excessive power consumption. In some examples, UE-based beam blockage prediction may be based on reference signal enhancements, triggering criteria, and UE reporting quantities. For example, the UE 115 may use an assistant reference signal for beam blockage including spatial and temporal measurements, where the UE 115 may determine statistical properties of the assistant reference signal, an output of the machine learning model, or both.

In some examples, a UE 115 may report a predicted beam blockage to a network entity 105. For example, the UE 115 may predict and report a beam blockage created by a moving object (e.g., a moving blocker). In the case of a moving object such as a pedestrian or a vehicle, beams transmitted by the network entity 105 with a fixed beam shape pattern may be blocked sequentially in a pattern specifically determined by the moving pattern of the object. Such blockages may impact beam switching patterns. In some examples, the UE 115 may predict and report the object's moving direction, and future beam switching patterns to avoid (using blocked beams) may be based on a particular implementation of the network entity 105. However, explicitly predicting such an object's moving direction, pattern, and speed may be highly sophisticated. In particular, measuring and performing supervised learning on the direction, pattern, and speed in which the object is moving may use additional inputs from a camera or sensor onboard the object (e.g., a moving vehicle) may be impractical. In addition, reporting the object's moving direction may be highly overhead consuming in 3D environments.

The wireless communications system 100 may support a UE 115 reporting future beam avoidance patterns based on a beam blockage prediction. That is, the UE 115 may report one or more beams (e.g., reference signal resources, such as synchronization signal blocks (SSBs), CSI-RSs, sounding reference signals (SRSs)) that the network entity 105 may avoid using during a quantity of future time domain windows. For example, the UE 115 may predict that SSB #1, SSB #3, SSB #5, and SSB #7 are going to be sequentially blocked during the upcoming 0 ms to 200 ms, 200 ms to 500 ms, 500 ms to 600 ms, and 600 ms to 700 ms, respectively, and that the network entity 105 is to avoid using these SSBs during the respective time periods. It may be beneficial for the UE 115 to report such predictions for multiple future time domain windows to inform the network entity 105 to be precautious when transmitting using potentially blocked resources. For example, the UE 115 may transmit the report for use cases such as extended reality (XR) (e.g., virtual reality (VR), augmented reality (AR), mixed reality (MR)) or other low-latency communications, where UE rotation may introduce dynamic blockages such that instantaneous blockage reporting regarding a relatively near future may not be prompt enough.

In some examples, training AI or machine learning models for such future beam blockage predictions may have a lower complexity than predicting a pattern of a moving object, and reporting such beam blockage predictions may use a lower overhead than reporting the object's predicted moving direction. For example, predicting beam blockages based on measured RSRPs of beams that may cause beam failures (e.g., a hypothesis physical downlink control channel (PDCCH) block error rate (BLER) calculated based on the RSRPs is below 10%) may reduce the complexity and overhead or reporting beam blockage predictions. Additionally, such beam blockage predictions may be associated with improved accuracy over BFD procedures that are based on monitoring performance regarding current operations, but fail to address whether a beam in an upcoming time domain occasion may be avoided due to a blockage (e.g., considering UE-proactive rotations in eMBB or XR scenarios). Moreover, the beam blockage prediction techniques described herein may directly predict RSRPs of beams for improved accuracy instead of using UE-predicted quantities that may represent chances of beams being blocked, or prediction targets that identify a set of weak RSRPs instead of strong RSRPs.

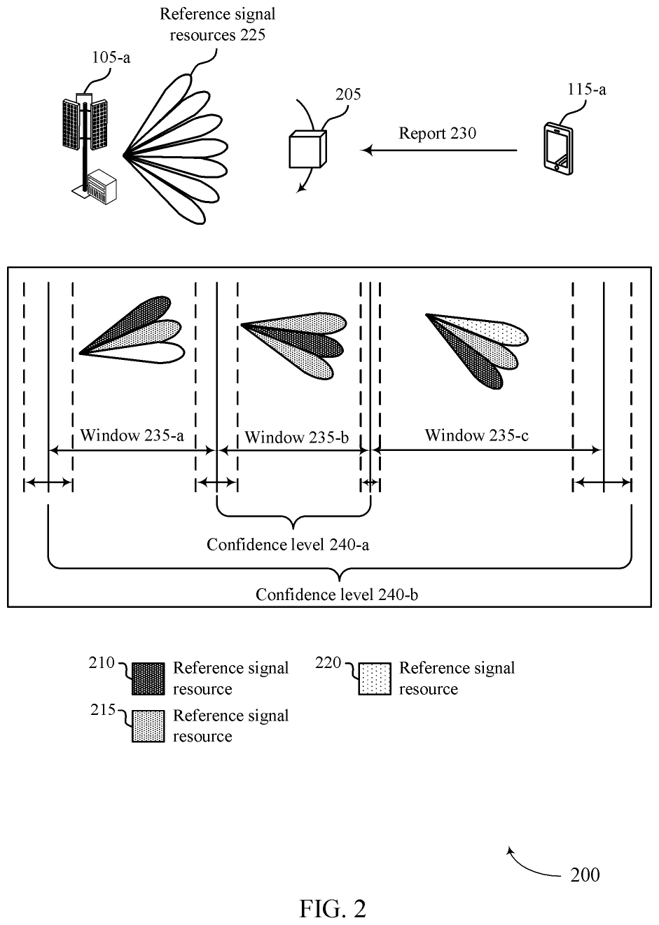

FIG. 2 illustrates an example of a wireless communications system 200 that supports event-triggered beam avoidance prediction reports in accordance with one or more aspects of the present disclosure. In some examples, the wireless communications system 200 may implement aspects of the wireless communications system 100 or may be implemented by aspects of the wireless communications system 100. For example, the wireless communications system 200 may include a UE 115-a and a network entity 105-a, which may be examples of corresponding devices as described herein. Additionally, the wireless communications system 200 may include an object 205, which may block signals transmitted from the network entity 105-a to the UE 115-a. For example, the object 205 may be a pedestrian, a vehicle, or the like.

In some examples, the network entity 105-a may transmit signals to the UE 115-a using set of reference signal resources 225. The set of reference signal resources 225 may include downlink reference signal resources such as SSB resources or CSI-RS resources. In some cases, the object 205 may block one or more of the set of reference signal resources 225 (e.g., and corresponding beams), which may result in dropped transmissions and overall degradation in quality of communications between the UE 115-a and the network entity 105-a. For example, the object may move with a particular direction, pattern, and speed, which may block different set of reference signal resources 225 or beams at any given time.

The wireless communications system 200 may support reporting beam blockage predictions by the UE 115-a, which may be event-triggered. In some examples, the UE 115-a may detect an event (e.g., a triggering event) based on a first quantity of reference signal resources, which may include one or more of a reference signal resource 210, a reference signal resource 215, or a reference signal resource 220. In some cases, the set of reference signal resources 225 (e.g., a second quantity of reference signal resources) may be a subset of the first quantity of reference signal resources. The UE 115-a may determine the event based on a beam-blockage alarm, which may be output by an AI or machine learning model that is configured by the network entity 105-a, and where inputs to the AI or machine learning model include measurement results associated with the first quantity of reference signal resources. That is, the UE 115-a may detect the event based on an output of the machine learning model that indicates a beam blockage, where one or more outputs of the machine learning model are associated with the first quantity of reference signal resources. Alternatively, the event may be based on L1-RSRP or channel impulse response (CIR) statistical patterns associated with the set of reference signal resources 225 and observed by the UE 115-a, where in some cases, the network entity 105-a may signal the patterns to the UE 115-a. That is, the UE 115-a may receive a message from the network entity 105-a indicating a pattern associated with the set of reference signal resources, and the UE 115-a may detect the event based on the pattern. Alternatively, the event may be based on an implementation of the UE 115-a.

In some cases, the event may be based on sensing-based methods at the UE 115-a, where the UE 115-a may proactively perform sensing to identify potential blockers (e.g., objects) or blockages. The UE 115-a may perform a sensing procedure to detect one or more objects that has a potential to block the set of reference signal resources 225, and the UE 115-a may generate the report 230 based on an output of the sensing procedure. That is, the triggering event may be based on some characteristics that are identified from an output of the sensing procedure. In some examples, the event may be based on the UE 115-a identifying an object that exceeds a volume or size threshold, where the network entity 105-a may configure and indicate the threshold. Alternatively, the event may be based on a distance between the blocking object and the UE 115-a or between the blocking object and the network entity 105-a being below a distance threshold, where the network entity 105-a may configure or indicate the distance threshold. In some other examples, the event may be based on the UE 115-a identifying that an angular spread associated with a particular reference signal resource of the set of reference signal resources 225 exceeds a threshold, where the UE 115-a may further identify that such an angular spread is created by a blocking object sensed by the UE 115-a, and where the network entity 105-a may configure and indicate the threshold.

In some cases, the event may trigger the UE 115-a to generate a report 230 (e.g., a beam avoidance prediction report) that indicates one or more of the set of reference signal resources 225 to be avoided by the network entity 105-a within a set of time domain windows 235 (e.g., using a QCL-TypeD source). Additionally, or alternatively, the report 230 may indicate just the set of time domain windows 235 during which the network entity 105-a is to avoid transmitting. The set of time domain windows 235 may include a time domain window 235-a, a time domain window 235-b, a time domain window 235-c, or any other time domain windows 235 during which the network entity 105-a may communicate with the UE 115-a. The UE 115-a may transmit the report 230 to the network entity 105-a such that the network entity 105-a may avoid transmitting using the set of reference signal resources 225 included in the report during the any of the time domain windows 235.

The UE 115-a may include confidence levels 240 in the report 230 with respect to the predicted beam avoidance, the time domain windows 235, or both. That is, when reporting the set of reference signal resources 225 to be avoided, or when reporting the first set of time domain windows 235 associated with the set of reference signal resources 225, the UE 115-a may additionally report confidence levels 240 associated with respective predicted beams. In some examples, the report 230 may include one or more of a first set of confidence levels associated with the set of reference signal resources 225 or a second set of confidence levels associated with the first set of time domain windows 235, where a confidence level 240 indicates a predicted level of severity (e.g., from 0% to 100% blockage) of a beam blockage. Alternatively, a confidence level 240 may be defined as a predicted standard deviation associated with the beginning and ending time domain occasion of the time domain windows 235. For example, the UE 115-a may report a confidence level 240-a which may correspond to the time domain window 235-a, or the UE 115-a may report a confidence level 240-b which may correspond to all of the time domain windows 235 during which the network entity 105-a may transmit using the set of reference signal resources 225.

In some cases, the first quantity of reference signal resources may include reference signal resources associated with different confidence levels. For example, the reference signal resources 210 may correspond to a relatively high confidence level to be avoided (e.g., 100% or another high percentage of being blocked during the corresponding time domain window 235), the reference signal resources 215 may correspond to an average confidence level to be avoided (e.g., 50%), and the reference signal resources 220 may correspond to a relatively low confidence level to be avoided (e.g., 10%).

In some examples, the network entity 105-a may determine whether to avoid particular beams or set of reference signal resources 225 based on the confidence levels 240 included in the report 230. For example, for a reference signal resource 225 that is reported with a high confidence level to be avoided, where the confidence level regarding an associated time domain window 235 (either being close to a current time or far from the current time) is also reported as high, the network entity 105-a may avoid switching a transmission beam to that direction during the associated time window without further verification. Alternatively, for a reference signal resource 225 that is reported with a high confidence level to be avoided, where the associated time domain window 235 is closer to the current time but is associated with a low to medium confidence level, or for a reference signal resource 225 that is reported with a low confidence level, where the associated time domain window 235 is closer to the current time also associated with a high confidence level, the network entity 105-a may trigger dynamic L1-RSRP reports to verify the UE predictions before it may switch the transmission beam to such direction. Alternatively, for a reference signal resource 225 that is reported with a low confidence level, where the associated time domain window 235 is far away from a current time, the network entity 105-a may trigger L1-RSRP reports regarding the reference signal resource 225 to verify the UE predictions.

The network entity 105-a may configure the quantity of set of reference signal resources 225 and the time domain windows 235. For example, the network entity 105-a may configure the quantity of set of reference signal resources 225 via an RRC configuration. Additionally, or alternatively, the network entity 105-a may use RRC signaling to configure the time domain windows 235 with different (e.g., quantized) window length and occasion options. In such cases, the UE 115-a may report respective option IDs when reporting the time domain windows 235 predicted to be associated with a beam blockage. For example, the UE 115-a may receive a control message (e.g., an RRC message) from the network entity 105-a indicating the quantity of set of reference signal resources 225, the time domain windows 235, or both, and the UE 115-a may transmit the report 230 indicating a set of IDs associated with one or more time domain windows 235, one or more confidence levels 240, or both based on receiving the control message.

The option IDs included in the report 230 may correspond to preconfigured options. For example, a preconfigured option may include a set of time domain windows 235 of a particular duration (e.g., 0 ms to 10 ms, 10 ms to 20 ms, . . . , 90 ms to 100 ms, 0 ms to 100 ms, 100 ms to 200 ms, . . . , 900 ms to 1000 ms), or having a “void” status, where a reported reference signal resource 225 associated with a “void” time domain window 235 indicates nothing for the reference signal resource 225. In some examples, the UE 115-a may report the set of reference signal resources 225 and, for each reference signal resource of the set of reference signal resources 225, the UE 115-a may further report the option ID regarding the associated time domain window 235 (e.g., future time domain window). Alternatively, the preconfigured options may correspond to each future time domain window that has a duration of 10 ms, 100 ms, or 1000 ms, where the UE 115-a may report a single option ID for each reference signal resource of the set of reference signal resources 225.

In some examples, the network entity 105-a may configure the confidence levels 240 with different (e.g., quantized) RRC options, while the UE 115-a may report respective options IDs when reporting the confidence levels 240. For example, if the confidence levels 240 associated with each reference signal resource of the set of reference signal resources 225 being blocked correspond to percentages (e.g., 0%, 10%, 20%, . . . , 90%, 100%), the UE 115-a may report an option ID corresponding to a confidence level 240 when reporting each reference signal resources of the set of reference signal resources 225. Alternatively, the confidence levels 240 associated with each reported time domain window 235 may be standard deviations in terms of milliseconds (e.g., 1 ms, 2 ms, . . . , 9 ms, 10 ms), and the UE 115-a may report the option IDs for the confidence levels 240 when reporting the time domain windows 235. In some other examples, the confidence levels 240 may be further grouped according to an indicated group of time domain windows 235 (e.g., time domain windows having lengths of 10 ms, 100 ms, or 1000 ms) are further grouped), and the UE 115-a may reduce a quantity of bits of the report 230 for reporting the confidence levels 240 by considering the group of confidence levels associated with the group of time domain windows 235.

The UE 115-a may use different reporting frameworks to transmit the report 230. For example, the UE 115-a may transmit the report 230 via an uplink MAC control element (MAC-CE), which may be based on transmitting a scheduling request physical uplink control channel (PUCCH) resource dedicated for such MAC-CEs if the UE 115-a lacks an uplink grant from the network entity 105-a. That is, the UE 115-a may transmit the report via the MAC-CE using a control channel resource based on transmitting the scheduling request. Alternatively, the UE 115-a may receive a grant for transmitting the MAC from the network entity 105-a, and the UE 115-a may transmit the report 230 via the MAC-CE based on receiving the grant. In this way, the network entity 105-a may allocate an appropriate quantity of uplink resources for the UE 115-a to transmit the report 230 via the MAC-CE.

In addition to SSBs and CSI-RSs, the UE 115-a may indicate one or more SRS resources to be avoided. For example, the UE 115-a may report the SRSs to be avoided as a transmit spatial filter reference for transmitting a PUCCH or a physical uplink shared channel (PUSCH), where the SRSs are associated with a future quantity of time domain windows. The transmit spatial filters may be associated with most recently transmitted SRS resources.

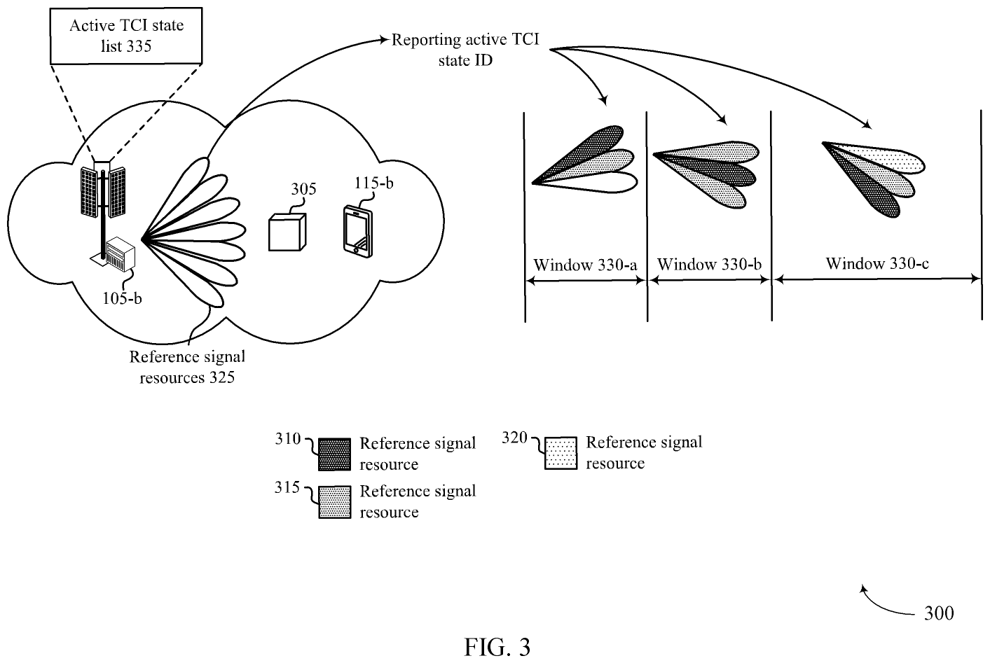

FIG. 3 illustrates an example of a wireless communications system 300 that supports event-triggered beam avoidance prediction reports in accordance with one or more aspects of the present disclosure. In some examples, the wireless communications system 300 may implement aspects of the wireless communications systems 100 and 200 or may be implemented by aspects of the wireless communications systems 100 and 200. For example, the wireless communications system 300 may include a UE 115-b and a network entity 105-b, which may be examples of corresponding devices as described herein. Additionally, the wireless communications system 300 may include an object 305, which may block signals transmitted from the network entity 105-b to the UE 115-b. For example, the object 305 may be a pedestrian, a vehicle, or the like.

As described herein with reference to FIG. 2, the network entity 105-b may transmit signals to the UE 115-b using set of reference signal resources 325. The set of reference signal resources 325 may include one or more downlink reference signal resources such as SSB resources or CSI-RS resources. In some cases, the object 305 may block one or more reference signal resources of the set of reference signal resources 325 (e.g., and corresponding beams), which may result in dropped transmissions and overall degradation in quality of communications between the UE 115-b and the network entity 105-b. For example, the object may move with a particular direction, pattern, and speed, which may block different set of reference signal resources 325 or beams at any given time.

The wireless communications system 300 may support reporting beam blockage predictions by the UE 115-b, which may be event-triggered. In some examples, the UE 115-b may detect an event (e.g., a triggering event) based on a first quantity of reference signal resources, which may include one or more of a reference signal resource 310, a reference signal resource 315, or a reference signal resource 320. In some cases, the set of reference signal resources 325 (e.g., a second quantity of reference signal resources) may be a subset of the first quantity of reference signal resources.

In some cases, the event may trigger the UE 115-b to generate a report (e.g., a beam avoidance prediction report) that indicates one or more of the set of reference signal resources 325 to be avoided by the network entity 105-b within a set of time domain windows 330. Additionally, or alternatively, the report may indicate just the set of time domain windows 330 during which the network entity 105-b is to avoid transmitting to the UE 115-b. The set of time domain windows 330 may include a time domain window 330-a, a time domain window 330-b, a time domain window 330-c, or any other time domain windows 330 during which the network entity 105-a may communicate with the UE 115-b. The UE 115-b may transmit the report to the network entity 105-a such that the network entity 105-b may avoid transmitting using the set of reference signal resources 325 included in the report during the any of the time domain windows 330.

In some cases, the UE 115-b may include confidence levels in the report, which may indicate a predicted level of severity of a beam blockage associated with a given reference signal resource of the set of reference signal resources 325. Accordingly, the first quantity of reference signal resources may include reference signal resources associated with different confidence levels. For example, the reference signal resources 310 may correspond to a relatively high confidence level to be avoided (e.g., 100% or another high percentage of being blocked during the corresponding time domain window 330), the reference signal resources 315 may correspond to an average confidence level to be avoided (e.g., 50%), and the reference signal resources 320 may correspond to a relatively low confidence level to be avoided (e.g., 10%).

In some examples, the UE 115-b may select which reference signal resources of the set of reference signal resources 325 to include in the report from a set of active TCI states. For example, the UE 115-b may report the set of reference signal resources 325 based on reporting a first quantity of TCI states of a TCI state list 335 being MAC-CE activated. If the UE 115-b is not activated with TCI states by a MAC-CE, the UE 115-a may report the set of reference signal resources 325 based on reporting a set of TCI states that may be at least default TypeD-QCL sources.

In some cases, a quantity of bits used for reporting a particular reference signal resource of the set of reference signal resources 325 may be based on a quantity of TCI states being activated by the MAC-CE. For example, if K TCI states are currently MAC-CE activated, the quantity of bits used for reporting a single reference signal resource of the set of reference signal resources 325 may be equal to [log₂ K]. In this way, the first quantity of reference signal resources may be considered as some reference signal resources associated with active TCI states of the active TCI state list 335.

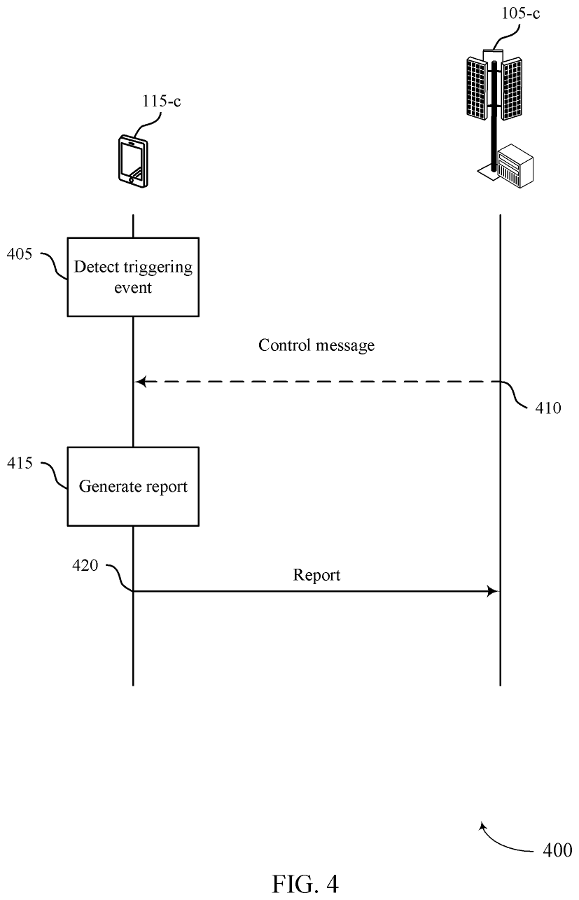

FIG. 4 illustrates an example of a process flow 400 that supports event-triggered beam avoidance prediction reports in accordance with one or more aspects of the present disclosure. The process flow 400 may implement aspects of wireless communications systems 100 and 200, or may be implemented by aspects of the wireless communications system 100 and 200. For example, the process flow 400 may illustrate operations between a UE 115-c and a network entity 105-c, which may be examples of corresponding devices described herein. In the following description of the process flow 400, the operations between the UE 115-c and the network entity 105-c may be transmitted in a different order than the example order shown, or the operations performed by the UE 115-c and the network entity 105-c may be performed in different orders or at different times. Some operations may also be omitted from the process flow 400, and other operations may be added to the process flow 400.

At 405, the UE 115-c may detect an event based on a first quantity of reference signal resources. The UE 115-c may detect the event based on a beam blockage alarm output from an AI or machine learning model that indicates a potential beam blockage associated with one or more of a second quantity of reference signal resources. Alternatively, the UE 115-c may detect the event based on a pattern indicted by the network entity 105-c, the pattern corresponding to an L1-RSRP or CIR statistical pattern associated with the first quantity of reference signal resources.

At 410, the UE 115-c may receive, from the network entity 105-c, a control message indicating the second quantity of reference signal resources, the first set of time domain windows, or both. In some examples, the control message may be an RRC configuration message.

At 415, the UE 115-c may generate a report based on the detected event, the report indicating one or more of the second quantity of reference signal resources to be avoided within a first set of time domain windows or the first set of time domain windows, where the second quantity of reference signal resources is a subset of the first quantity of reference signal resources. In some examples, the report may include confidence levels associated with the second quantity of reference signal resources, the first set of time domain windows, or both, where a confidence interval may indicate a predicted level of severity of a beam blockage (e.g., 0%, 50%, 100%). In some examples, the UE 115-c may include the second quantity of reference signal resources in the report based on one or more TCI states of an active TCI state list that are associated with the second quantity of reference signal resources.

At 420, the UE 115-c may transmit the report to the network entity 105-c. In some examples, the UE 115-c may transmit the report indicating a set of IDs associated with the first set of time domain windows, the confidence intervals, or both based on receiving the control message from the network entity 105-c. In some cases, the UE 115-c may transmit the report to the network entity 105-c via a MAC-CE using a control channel resources based on transmitting a scheduling request, or the UE 115-c may receive a grant from the network entity 105-c enabling the UE 115-c to transmit the report via the MAC-CE.

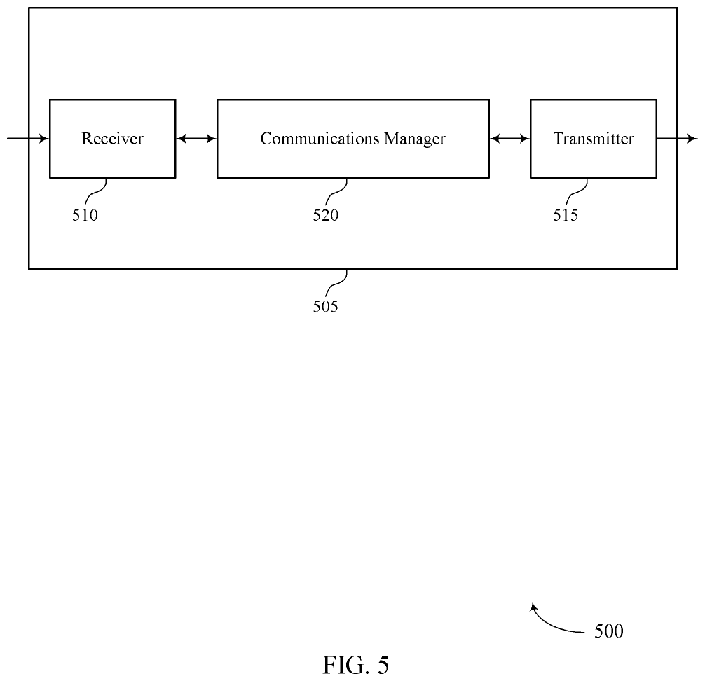

FIG. 5 shows a block diagram 500 of a device 505 that supports event-triggered beam avoidance prediction reports in accordance with one or more aspects of the present disclosure. The device 505 may be an example of aspects of a UE 115 as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to event-triggered beam avoidance prediction reports). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to event-triggered beam avoidance prediction reports). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations thereof or various components thereof may be examples of means for performing various aspects of event-triggered beam avoidance prediction reports as described herein. For example, the communications manager 520, the receiver 510, the transmitter 515, or various combinations or components thereof may support a method for performing one or more of the functions described herein.

In some examples, the communications manager 520, the receiver 510, the transmitter 515, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 520, the receiver 510, the transmitter 515, or various combinations or components thereof may be implemented in code (e.g., as communications management software or firmware) executed by a processor. If implemented in code executed by a processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communication at a UE in accordance with examples as disclosed herein. For example, the communications manager 520 may be configured as or otherwise support a means for detecting an event based on a first quantity of reference signal resources. The communications manager 520 may be configured as or otherwise support a means for generating a report based on the detected event, the report indicating one or more of a second quantity of reference signal resources to be avoided within a first set of time domain windows or the first set of time domain windows, where the second quantity of reference signal resources is a subset of the first quantity of reference signal resources. The communications manager 520 may be configured as or otherwise support a means for transmitting the report to a network entity.

By including or configuring the communications manager 520 in accordance with examples as described herein, the device 505 (e.g., a processor controlling or otherwise coupled with the receiver 510, the transmitter 515, the communications manager 520, or a combination thereof) may support techniques for event-triggered beam avoidance prediction reporting, which may reduce blocked transmissions, increase signaling throughput, improve communicates between wireless devices, and provide for more accurate beam blockage reporting.

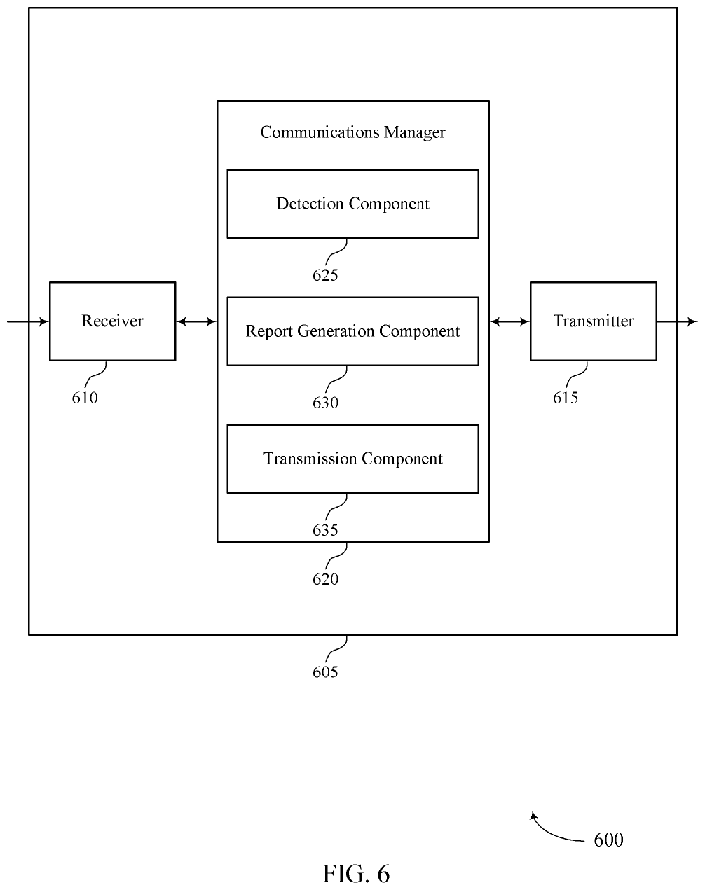

FIG. 6 shows a block diagram 600 of a device 605 that supports event-

triggered beam avoidance prediction reports in accordance with one or more aspects of the present disclosure. The device 605 may be an example of aspects of a device 505 or a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to event-triggered beam avoidance prediction reports). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to event-triggered beam avoidance prediction reports). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of event-triggered beam avoidance prediction reports as described herein. For example, the communications manager 620 may include a detection component 625, a report generation component 630, a transmission component 635, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communication at a UE in accordance with examples as disclosed herein. The detection component 625 may be configured as or otherwise support a means for detecting an event based on a first quantity of reference signal resources. The report generation component 630 may be configured as or otherwise support a means for generating a report based on the detected event, the report indicating one or more of a second quantity of reference signal resources to be avoided within a first set of time domain windows or the first set of time domain windows, where the second quantity of reference signal resources is a subset of the first quantity of reference signal resources. The transmission component 635 may be configured as or otherwise support a means for transmitting the report to a network entity.

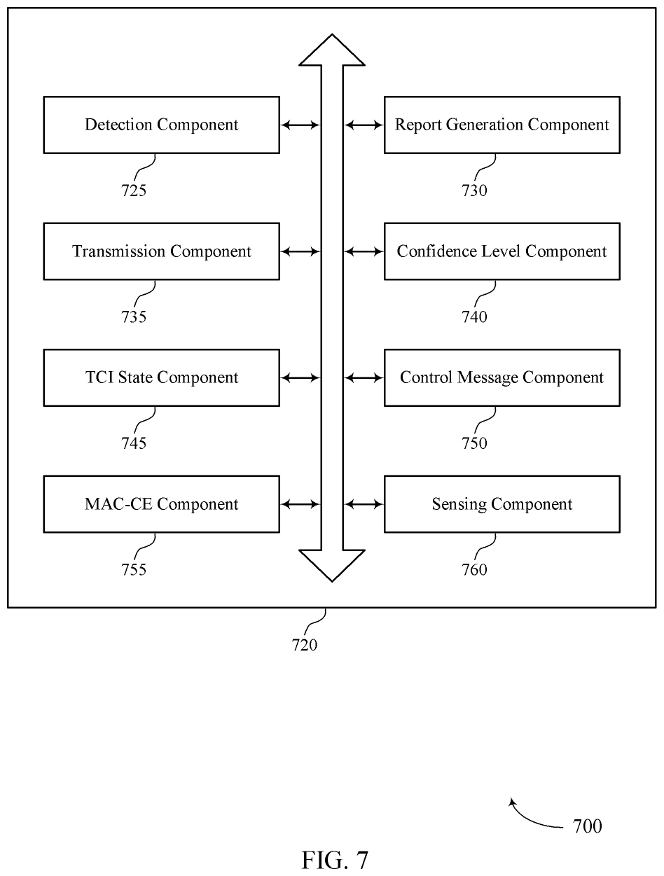

FIG. 7 shows a block diagram 700 of a communications manager 720 that supports event-triggered beam avoidance prediction reports in accordance with one or more aspects of the present disclosure. The communications manager 720 may be an example of aspects of a communications manager 520, a communications manager 620, or both, as described herein. The communications manager 720, or various components thereof, may be an example of means for performing various aspects of event-triggered beam avoidance prediction reports as described herein. For example, the communications manager 720 may include a detection component 725, a report generation component 730, a transmission component 735, a confidence level component 740, a TCI state component 745, a control message component 750, a MAC-CE component 755, a sensing component 760, or any combination thereof. Each of these components may communicate, directly or indirectly, with one another (e.g., via one or more buses).

The communications manager 720 may support wireless communication at a UE in accordance with examples as disclosed herein. The detection component 725 may be configured as or otherwise support a means for detecting an event based on a first quantity of reference signal resources. The report generation component 730 may be configured as or otherwise support a means for generating a report based on the detected event, the report indicating one or more of a second quantity of reference signal resources to be avoided within a first set of time domain windows or the first set of time domain windows, where the second quantity of reference signal resources is a subset of the first quantity of reference signal resources. The transmission component 735 may be configured as or otherwise support a means for transmitting the report to a network entity.

In some examples, to support transmitting the report, the confidence level component 740 may be configured as or otherwise support a means for transmitting, in the report, one or more of a first set of confidence levels associated with the second quantity of reference signal resources or a second set of confidence levels associated with the first set of time domain windows, where a confidence level indicates a predicted level of severity of a beam blockage.

In some examples, to support transmitting the report, the TCI state component 745 may be configured as or otherwise support a means for transmitting the report based on one or more TCI states of a set of TCI states associated with the second quantity of reference signal resources.

In some examples, the control message component 750 may be configured as or otherwise support a means for receiving a control message indicating the second quantity of reference signal resources, the first set of time domain windows, or both. In some examples, the transmission component 735 may be configured as or otherwise support a means for transmitting the report indicating a set of IDs associated with one or more of the first set of time domain windows, or one or more confidence levels based on receiving the control message.

In some examples, to support transmitting the report, the MAC-CE component 755 may be configured as or otherwise support a means for transmitting the report via a MAC-CE using a control channel resource based on transmitting a scheduling request.

In some examples, to support transmitting the report, the MAC-CE component 755 may be configured as or otherwise support a means for receiving, from the network entity, a grant for transmitting a MAC-CE. In some examples, to support transmitting the report, the MAC-CE component 755 may be configured as or otherwise support a means for transmitting the report via the MAC-CE based on receiving the grant.

In some examples, to support detecting the event, the detection component 725 may be configured as or otherwise support a means for detecting the event based on an output of a machine learning model that indicates a beam blockage, where one or more inputs of the machine learning model are associated with the first quantity of reference signal resources.

In some examples, to support detecting the event, the detection component 725 may be configured as or otherwise support a means for receiving, from the network entity, a message indicating a pattern associated with the first quantity of reference signal resources. In some examples, to support detecting the event, the detection component 725 may be configured as or otherwise support a means for detecting the event based on the pattern.

In some examples, the sensing component 760 may be configured as or otherwise support a means for performing a sensing procedure to detect one or more objects that has a potential to block the second quantity of reference signal resources. In some examples, the transmission component 735 may be configured as or otherwise support a means for generating the report based on an output of the sensing procedure.

In some examples, the second quantity of reference signal resources includes one or more SSB resources, channel state information reference signal resources, or sounding reference signal resources.

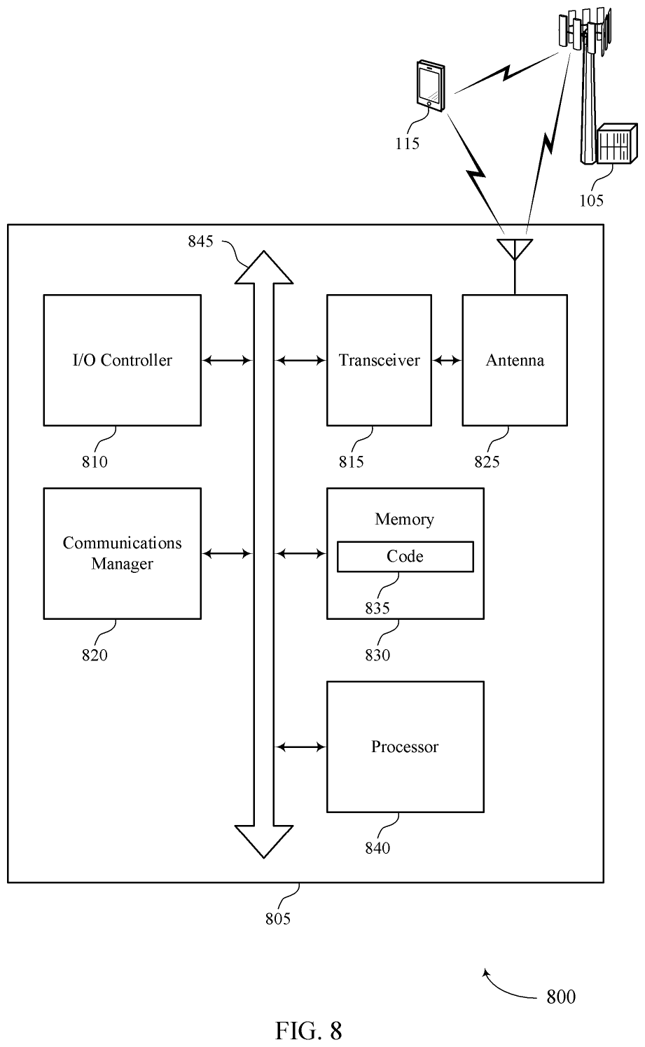

FIG. 8 shows a diagram of a system 800 including a device 805 that supports event-triggered beam avoidance prediction reports in accordance with one or more aspects of the present disclosure. The device 805 may be an example of or include the components of a device 505, a device 605, or a UE 115 as described herein. The device 805 may communicate (e.g., wirelessly) with one or more network entities 105, one or more UEs 115, or any combination thereof. The device 805 may include components for bi-directional voice and data communications including components for transmitting and receiving communications, such as a communications manager 820, an input/output (I/O) controller 810, a transceiver 815, an antenna 825, a memory 830, code 835, and a processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of a processor, such as the processor 840. In some cases, a user may interact with the device 805 via the I/O controller 810 or via hardware components controlled by the I/O controller 810.

In some cases, the device 805 may include a single antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The memory 830 may include random access memory (RAM) and read-only memory (ROM). The memory 830 may store computer-readable, computer-executable code 835 including instructions that, when executed by the processor 840, cause the device 805 to perform various functions described herein. The code 835 may be stored in a non-transitory computer-readable medium such as system memory or another type of memory. In some cases, the code 835 may not be directly executable by the processor 840 but may cause a computer (e.g., when compiled and executed) to perform functions described herein. In some cases, the memory 830 may contain, among other things, a basic I/O system (BIOS) which may control basic hardware or software operation such as the interaction with peripheral components or devices.

The processor 840 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 840 may be configured to operate a memory array using a memory controller. In some other cases, a memory controller may be integrated into the processor 840. The processor 840 may be configured to execute computer-readable instructions stored in a memory (e.g., the memory 830) to cause the device 805 to perform various functions (e.g., functions or tasks supporting event-triggered beam avoidance prediction reports). For example, the device 805 or a component of the device 805 may include a processor 840 and memory 830 coupled with or to the processor 840, the processor 840 and memory 830 configured to perform various functions described herein.

The communications manager 820 may support wireless communication at a UE in accordance with examples as disclosed herein. For example, the communications manager 820 may be configured as or otherwise support a means for detecting an event based on a first quantity of reference signal resources. The communications manager 820 may be configured as or otherwise support a means for generating a report based on the detected event, the report indicating one or more of a second quantity of reference signal resources to be avoided within a first set of time domain windows or the first set of time domain windows, where the second quantity of reference signal resources is a subset of the first quantity of reference signal resources. The communications manager 820 may be configured as or otherwise support a means for transmitting the report to a network entity.

By including or configuring the communications manager 820 in accordance with examples as described herein, the device 805 may support techniques for event-triggered beam avoidance prediction reporting, which may reduce blocked transmissions, increase signaling throughput, improve communicates between wireless devices, and provide for more accurate beam blockage reporting.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the processor 840, the memory 830, the code 835, or any combination thereof. For example, the code 835 may include instructions executable by the processor 840 to cause the device 805 to perform various aspects of event-triggered beam avoidance prediction reports as described herein, or the processor 840 and the memory 830 may be otherwise configured to perform or support such operations.

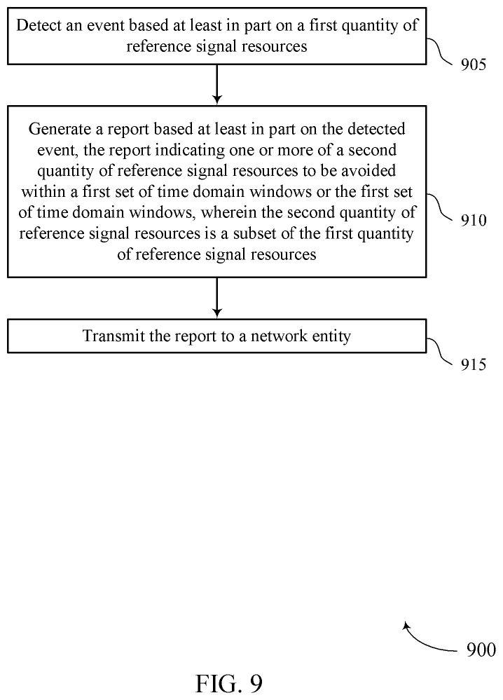

FIG. 9 shows a flowchart illustrating a method 900 that supports event-triggered beam avoidance prediction reports in accordance with one or more aspects of the present disclosure. The operations of the method 900 may be implemented by a UE or its components as described herein. For example, the operations of the method 900 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 905, the method may include detecting an event based on a first quantity of reference signal resources. The operations of 905 may be performed in accordance with examples as disclosed herein. In some examples, aspects of the operations of 905 may be performed by a detection component 725 as described with reference to FIG. 7.

At 910, the method may include generating a report based on the detected event, the report indicating one or more of a second quantity of reference signal resources to be avoided within a first set of time domain windows or the first set of time domain windows, where the second quantity of reference signal resources is a subset of the first quantity of reference signal resources. The operations of 910 may be performed in accordance with examples as disclosed herein. In some examples, aspects of the operations of 910 may be performed by a report generation component 730 as described with reference to FIG. 7.

At 915, the method may include transmitting the report to a network entity. The operations of 915 may be performed in accordance with examples as disclosed herein. In some examples, aspects of the operations of 915 may be performed by a transmission component 735 as described with reference to FIG. 7.

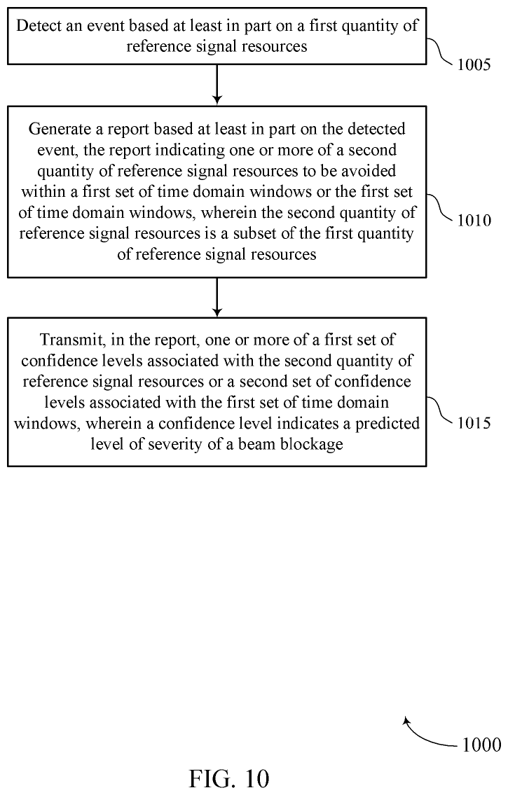

FIG. 10 shows a flowchart illustrating a method 1000 that supports event-triggered beam avoidance prediction reports in accordance with one or more aspects of the present disclosure. The operations of the method 1000 may be implemented by a UE or its components as described herein. For example, the operations of the method 1000 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1005, the method may include detecting an event based on a first quantity of reference signal resources. The operations of 1005 may be performed in accordance with examples as disclosed herein. In some examples, aspects of the operations of 1005 may be performed by a detection component 725 as described with reference to FIG. 7.

At 1010, the method may include generating a report based on the detected event, the report indicating one or more of a second quantity of reference signal resources to be avoided within a first set of time domain windows or the first set of time domain windows, where the second quantity of reference signal resources is a subset of the first quantity of reference signal resources. The operations of 1010 may be performed in accordance with examples as disclosed herein. In some examples, aspects of the operations of 1010 may be performed by a report generation component 730 as described with reference to FIG. 7.

At 1015, the method may include transmitting, in the report, one or more of a first set of confidence levels associated with the second quantity of reference signal resources or a second set of confidence levels associated with the first set of time domain windows, where a confidence level indicates a predicted level of severity of a beam blockage. The operations of 1015 may be performed in accordance with examples as disclosed herein. In some examples, aspects of the operations of 1015 may be performed by a confidence level component 740 as described with reference to FIG. 7.

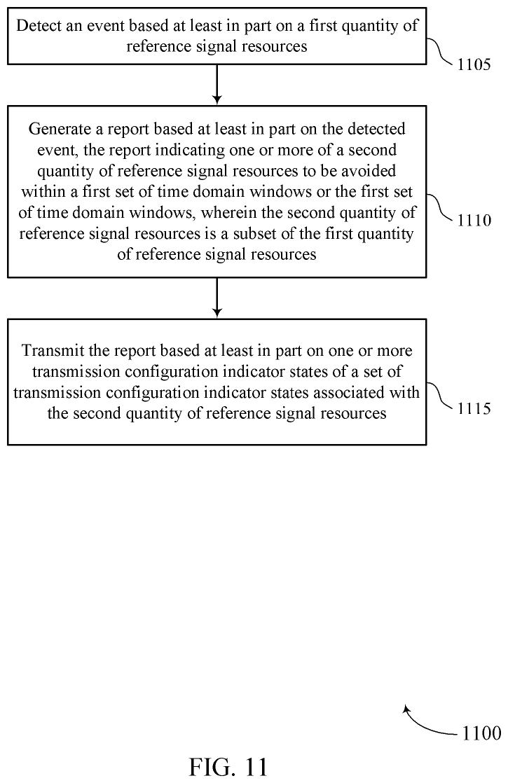

FIG. 11 shows a flowchart illustrating a method 1100 that supports event-triggered beam avoidance prediction reports in accordance with one or more aspects of the present disclosure. The operations of the method 1100 may be implemented by a UE or its components as described herein. For example, the operations of the method 1100 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1105, the method may include detecting an event based on a first quantity of reference signal resources. The operations of 1105 may be performed in accordance with examples as disclosed herein. In some examples, aspects of the operations of 1105 may be performed by a detection component 725 as described with reference to FIG. 7.

At 1110, the method may include generating a report based on the detected event, the report indicating one or more of a second quantity of reference signal resources to be avoided within a first set of time domain windows or the first set of time domain windows, where the second quantity of reference signal resources is a subset of the first quantity of reference signal resources. The operations of 1110 may be performed in accordance with examples as disclosed herein. In some examples, aspects of the operations of 1110 may be performed by a report generation component 730 as described with reference to FIG. 7.

At 1115, the method may include transmitting the report based on one or more TCI states of a set of TCI states associated with the second quantity of reference signal resources. The operations of 1115 may be performed in accordance with examples as disclosed herein. In some examples, aspects of the operations of 1115 may be performed by a TCI state component 745 as described with reference to FIG. 7.

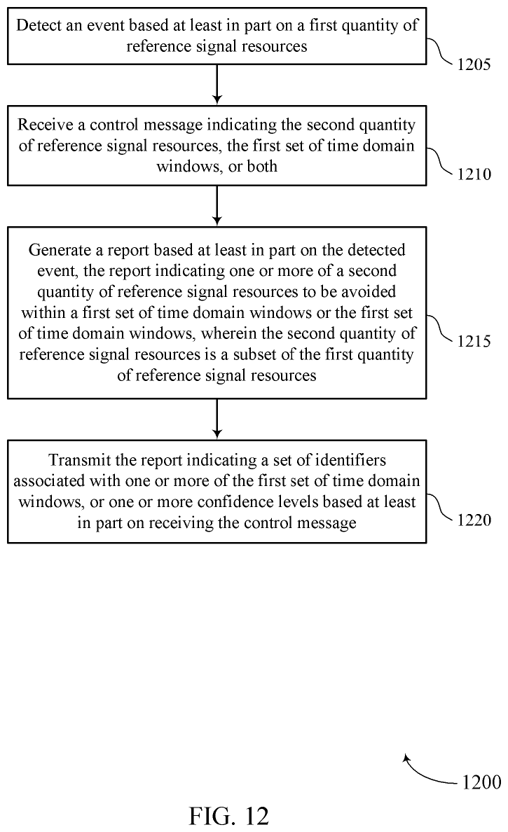

FIG. 12 shows a flowchart illustrating a method 1200 that supports event-triggered beam avoidance prediction reports in accordance with one or more aspects of the present disclosure. The operations of the method 1200 may be implemented by a UE or its components as described herein. For example, the operations of the method 1200 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1205, the method may include detecting an event based on a first quantity of reference signal resources. The operations of 1205 may be performed in accordance with examples as disclosed herein. In some examples, aspects of the operations of 1205 may be performed by a detection component 725 as described with reference to FIG. 7.

At 1210, the method may include receiving a control message indicating the second quantity of reference signal resources, the first set of time domain windows, or both. The operations of 1210 may be performed in accordance with examples as disclosed herein. In some examples, aspects of the operations of 1210 may be performed by a control message component 750 as described with reference to FIG. 7.

At 1215, the method may include generating a report based on the detected event, the report indicating one or more of a second quantity of reference signal resources to be avoided within a first set of time domain windows or the first set of time domain windows, where the second quantity of reference signal resources is a subset of the first quantity of reference signal resources. The operations of 1215 may be performed in accordance with examples as disclosed herein. In some examples, aspects of the operations of 1215 may be performed by a report generation component 730 as described with reference to FIG. 7.

At 1220, the method may include transmitting the report indicating a set of IDs associated with one or more of the first set of time domain windows, or one or more confidence levels based on receiving the control message. The operations of 1220 may be performed in accordance with examples as disclosed herein. In some examples, aspects of the operations of 1220 may be performed by a transmission component 735 as described with reference to FIG. 7.

The following provides an overview of aspects of the present disclosure:

Aspect 1: A method for wireless communication at a UE, comprising: detecting an event based at least in part on a first quantity of reference signal resources; generating a report based at least in part on the detected event, the report indicating one or more of a second quantity of reference signal resources to be avoided within a first set of time domain windows or the first set of time domain windows, wherein the second quantity of reference signal resources is a subset of the first quantity of reference signal resources; and transmitting the report to a network entity.

Aspect 2: The method of aspect 1, wherein transmitting the report comprises: transmitting, in the report, one or more of a first set of confidence levels associated with the second quantity of reference signal resources or a second set of confidence levels associated with the first set of time domain windows, wherein a confidence level indicates a predicted level of severity of a beam blockage.

Aspect 3: The method of any of aspects 1 through 2, wherein transmitting the report comprises: transmitting the report based at least in part on one or more TCI states of a set of TCI states associated with the second quantity of reference signal resources.

Aspect 4: The method of any of aspects 1 through 3, further comprising: receiving a control message indicating the second quantity of reference signal resources, the first set of time domain windows, or both; and transmitting the report indicating a set of IDs associated with one or more of the first set of time domain windows, or one or more confidence levels based at least in part on receiving the control message.

Aspect 5: The method of any of aspects 1 through 4, wherein transmitting the report comprises: transmitting the report via a MAC-CE using a control channel resource based at least in part on transmitting a scheduling request.

Aspect 6: The method of any of aspects 1 through 5, wherein transmitting the report comprises: receiving, from the network entity, a grant for transmitting a MAC-CE; and transmitting the report via the MAC-CE based at least in part on receiving the grant.

Aspect 7: The method of any of aspects 1 through 6, wherein detecting the event comprises: detecting the event based at least in part on an output of a machine learning model that indicates a beam blockage, wherein one or more inputs of the machine learning model are associated with the first quantity of reference signal resources.

Aspect 8: The method of any of aspects 1 through 7, wherein detecting the event comprises: receiving, from the network entity, a message indicating a pattern associated with the first quantity of reference signal resources; and detecting the event based at least in part on the pattern.

Aspect 9: The method of any of aspects 1 through 8, further comprising: performing a sensing procedure to detect one or more objects that has a potential to block the second quantity of reference signal resources; and generating the report based at least in part on an output of the sensing procedure.

Aspect 10: The method of any of aspects 1 through 9, wherein the second quantity of reference signal resources comprises one or more SSB resources, CSI-RS resources, or SRS resources.

Aspect 11: An apparatus for wireless communication at a UE, comprising a processor; memory coupled with the processor; and instructions stored in the memory and executable by the processor to cause the apparatus to perform a method of any of aspects 1 through 10.

Aspect 12: An apparatus for wireless communication at a UE, comprising at least one means for performing a method of any of aspects 1 through 10.

Aspect 13: A non-transitory computer-readable medium storing code for wireless communication at a UE, the code comprising instructions executable by a processor to perform a method of any of aspects 1 through 10.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communication at a user equipment (UE), comprising:
a processor:
memory coupled with the processor: and instructions stored in the memory and executable by the processor to cause the apparatus to:
detect an event based at least in part on a first quantity of reference signal resources:
generate a report based at least in part on the detected event, the report indicating one or more of a second quantity of reference signal resources to be avoided within a first set of time domain windows or the first set of time domain windows, wherein the second quantity of reference signal resources is a subset of the first quantity of reference signal resources; and
transmit the report to a network entity.

2. The apparatus of claim 1, wherein the instructions to transmit the report are executable by the processor to cause the apparatus to:
transmit, in the report, one or more of a first set of confidence levels associated with the second quantity of reference signal resources or a second set of confidence levels associated with the first set of time domain windows, wherein a confidence level indicates a predicted level of severity of a beam blockage.

3. The apparatus of claim 1, wherein the instructions to transmit the report are executable by the processor to cause the apparatus to:
transmit the report based at least in part on one or more transmission configuration indicator states of a set of transmission configuration indicator states associated with the second quantity of reference signal resources.

4. The apparatus of claim 1, wherein the instructions are further executable by the processor to cause the apparatus to:
receive a control message indicating the second quantity of reference signal resources, the first set of time domain windows, or both; and
transmit the report indicating a set of identifiers associated with one or more of the first set of time domain windows, or one or more confidence levels based at least in part on receiving the control message.

5. The apparatus of claim 1, wherein the instructions to transmit the report are executable by the processor to cause the apparatus to:
transmit the report via a medium access control control element using a control channel resource based at least in part on transmitting a scheduling request.

6. The apparatus of claim 1, wherein the instructions to transmit the report are executable by the processor to cause the apparatus to:
receive, from the network entity, a grant for transmitting a medium access control control element; and
transmit the report via the medium access control control element based at least in part on receiving the grant.

7. The apparatus of claim 1, wherein the instructions to detect the event are executable by the processor to cause the apparatus to:
detect the event based at least in part on an output of a machine learning model that indicates a beam blockage, wherein one or more inputs of the machine learning model are associated with the first quantity of reference signal resources.

8. The apparatus of claim 1, wherein the instructions to detect the event are executable by the processor to cause the apparatus to:
receive, from the network entity, a message indicating a pattern associated with the first quantity of reference signal resources; and
detect the event based at least in part on the pattern.

9. The apparatus of claim 1, wherein the instructions are further executable by the processor to cause the apparatus to:
perform a sensing procedure to detect one or more objects that has a potential to block the second quantity of reference signal resources; and
generate the report based at least in part on an output of the sensing procedure.

10. The apparatus of claim 1, wherein:
the second quantity of reference signal resources comprises one or more synchronization signal block resources, channel state information reference signal resources, or sounding reference signal resources.

11. A method for wireless communication at a user equipment (UE), comprising:
detecting an event based at least in part on a first quantity of reference signal resources;
generating a report based at least in part on the detected event, the report indicating one or more of a second quantity of reference signal resources to be avoided within a first set of time domain windows or the first set of time domain windows, wherein the second quantity of reference signal resources is a subset of the first quantity of reference signal resources; and
transmitting the report to a network entity.

12. The method of claim 11, wherein transmitting the report comprises:
transmitting, in the report, one or more of a first set of confidence levels associated with the second quantity of reference signal resources or a second set of confidence levels associated with the first set of time domain windows, wherein a confidence level indicates a predicted level of severity of a beam blockage.

13. The method of claim 11, wherein transmitting the report comprises:
transmitting the report based at least in part on one or more transmission configuration indicator states of a set of transmission configuration indicator states associated with the second quantity of reference signal resources.

14. The method of claim 11, further comprising:
receiving a control message indicating the second quantity of reference signal resources, the first set of time domain windows, or both; and
transmitting the report indicating a set of identifiers associated with one or more of the first set of time domain windows, or one or more confidence levels based at least in part on receiving the control message.

15. The method of claim 11, wherein transmitting the report comprises:
transmitting the report via a medium access control control element using a control channel resource based at least in part on transmitting a scheduling request.

16. The method of claim 11, wherein transmitting the report comprises:
receiving, from the network entity, a grant for transmitting a medium access control control element; and
transmitting the report via the medium access control control element based at least in part on receiving the grant.

17. The method of claim 11, wherein detecting the event comprises:
detecting the event based at least in part on an output of a machine learning model that indicates a beam blockage, wherein one or more inputs of the machine learning model are associated with the first quantity of reference signal resources.

18. The method of claim 11, wherein detecting the event comprises:
receiving, from the network entity, a message indicating a pattern associated with the first quantity of reference signal resources; and
detecting the event based at least in part on the pattern.

19. The method of claim 11, further comprising:
performing a sensing procedure to detect one or more objects that has a potential to block the second quantity of reference signal resources; and
generating the report based at least in part on an output of the sensing procedure.

20. The method of claim 11, wherein the second quantity of reference signal resources comprises one or more synchronization signal block resources, channel state information reference signal resources, or sounding reference signal resources.

21. A non-transitory computer-readable medium storing code for wireless communication at a user equipment (UE), the code comprising instructions executable by a processor to:
detect an event based at least in part on a first quantity of reference signal resources:
generate a report based at least in part on the detected event, the report indicating one or more of a second quantity of reference signal resources to be avoided within a first set of time domain windows or the first set of time domain windows, wherein the second quantity of reference signal resources is a subset of the first quantity of reference signal resources; and
transmit the report to a network entity.

22. The non-transitory computer-readable medium of claim 21, wherein the instructions to transmit the report are executable by the processor to:
transmit, in the report, one or more of a first set of confidence levels associated with the second quantity of reference signal resources or a second set of confidence levels associated with the first set of time domain windows, wherein a confidence level indicates a predicted level of severity of a beam blockage.

23. The non-transitory computer-readable medium of claim 21, wherein the instructions to transmit the report are executable by the processor to:
transmit the report based at least in part on one or more transmission configuration indicator states of a set of transmission configuration indicator states associated with the second quantity of reference signal resources.

24. The non-transitory computer-readable medium of claim 21, wherein the instructions are further executable by the processor to:
receive a control message indicating the second quantity of reference signal resources, the first set of time domain windows, or both; and
transmit the report indicating a set of identifiers associated with one or more of the first set of time domain windows, or one or more confidence levels based at least in part on receiving the control message.

25. The non-transitory computer-readable medium of claim 21, wherein the instructions to transmit the report are executable by the processor to:
transmit the report via a medium access control control element using a control channel resource based at least in part on transmitting a scheduling request.

26. The non-transitory computer-readable medium of claim 21, wherein the instructions to transmit the report are executable by the processor to:
receive, from the network entity, a grant for transmitting a medium access control control element; and
transmit the report via the medium access control control element based at least in part on receiving the grant.

27. The non-transitory computer-readable medium of claim 21, wherein the instructions to detect the event are executable by the processor to:
detect the event based at least in part on an output of a machine learning model that indicates a beam blockage, wherein one or more inputs of the machine learning model are associated with the first quantity of reference signal resources.

28. The non-transitory computer-readable medium of claim 21, wherein the instructions to detect the event are executable by the processor to:
receive, from the network entity, a message indicating a pattern associated with the first quantity of reference signal resources: and detect the event based at least in part on the pattern.

29. The non-transitory computer-readable medium of claim 21, wherein the instructions are further executable by the processor to:
perform a sensing procedure to detect one or more objects that has a potential to block the second quantity of reference signal resources; and
generate the report based at least in part on an output of the sensing procedure.

30. An apparatus for wireless communication at a user equipment (UE), comprising:
means for detecting an event based at least in part on a first quantity of reference signal resources;
means for generating a report based at least in part on the detected event, the report indicating one or more of a second quantity of reference signal resources to be avoided within a first set of time domain windows or the first set of time domain windows, wherein the second quantity of reference signal resources is a subset of the first quantity of reference signal resources; and
means for transmitting the report to a network entity.
